(19) United States
(12) Patent Application Publication
(10) Pub. No.: US 2017/0100791 A1
(43) Pub. Date: Apr. 13, 2017

(54) THREADING TOOLS

(71) Applicants: James E. Hamm, Grafton, OH (US); Donald A. Haradem, Avon, OH (US)

(72) Inventors: James E. Hamm, Grafton, OH (US); Donald A. Haradem, Avon, OH (US)

(73) Assignee: Ridge Tool Company, Elyria, OH (US)

(21) Appl. No.: 15/176,353

(22) Filed: Jun. 8, 2016

Related U.S. Application Data
(60) Provisional application No. 62/238,792, filed on Oct. 8, 2015.

(51) Int. Cl. B23G 5/00; B05B 9/01

(52) U.S. Cl. CPC B23G 5/005; B05B 9/01; B23G 2240/12

(57) ABSTRACT

Various tools are described which can be used for applying axial force to a die head such as during a thread forming operation performed on a pipe. The tools include provisions for selectively dispensing liquid agents such as oil or cutting agents to the die head or region of interest. The tools also include a member adapted for contacting an end face of a die head and transferring axial force thereto.

### CROSS REFERENCES TO RELATED APPLICATIONS

The present application claims priority upon U.S. provisional application Ser. No. 62/238,792 filed Oct. 8, 2015.

### FIELD

The present subject matter relates to handheld tools having dispensers for oil or liquid cutting agents and provisions for applying force to a threading die head.

### BACKGROUND

Liquid cutting agents and/or oils are typically applied during thread forming operations such as may be performed upon tubular workpieces such as pipes. The cutting agents or oils are applied to a thread forming die head and/or directly to the workpiece. Often, a handheld liquid dispenser is used.

During thread forming operations using a die head, one or both of a die head and tubular work piece are rotated. The die head contains one or more thread forming members that “cut” or otherwise form desired thread(s) in the workpiece. During such thread formation, a user applies axial force to the die head to promote thread formation from a distal end of the workpiece and inward from that end. Application of such force may be only periodic or intermittent, or can in certain applications be continual throughout the entirety of thread formation.

Tools are known for applying axial force to a die head. However, it is difficult for a single user to apply the noted axial force, dispense cutting agents or oils, adjust cutting thread depth, and/or monitor other aspects of the thread forming operation.

Accordingly, a need exists for a manner by which a user can more easily perform the various tasks associated with thread forming.

### SUMMARY

The difficulties and drawbacks associated with previous approaches are addressed in the present subject matter as follows.

In one aspect, the present subject matter provides a tool for applying force to a die head. The tool comprises a tool housing including a handle. The tool also comprises a die head member affixed to the housing and adapted for contacting and transferring force to a thread forming die head. The tool additionally comprises a spout extending from at least one of the tool housing and the die head member. The spout defines a distal end through which liquid can flow and exit the spout.

In another aspect, the present subject matter provides a tool for applying axial force to a die head. The tool comprises a tool housing including a handle. The tool also comprises a rotatable die head member engaged with the housing and adapted for contacting and transferring force to a die head. The tool additionally comprises a spout extending from one of the tool housing and the die head member. The spout defines a distal end through which liquid can flow and exit the spout. The tool also comprises a liquid dispensing assembly including a trigger.

In yet another aspect, the present subject matter provides a method for applying force to a die head during a threading operation and applying a liquid to the die head or region of interest. The method comprises providing a tool including a tool housing having a handle, a die head member affixed to the housing and adapted for contacting and transferring force to the die head, a spout defining a distal end through which liquid can flow and exit the spout, and a liquid dispensing assembly. Actuation of the liquid dispensing assembly displaces liquid to the distal end of the spout. The method also comprises contacting the die head member of the tool with a die head and applying force to the die head. The method additionally comprises actuating the liquid dispensing assembly of the tool to thereby displace liquid to the distal end of the spout and dispense liquid from the tool to the die head or region of interest.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a perspective view of an embodiment of a threading tool in accordance with the present subject matter.

FIG. 2 illustrates use of the threading tool depicted in FIG. 1 and application of axial force to a thread forming die head.

FIG. 3 illustrates use of the threading tool depicted in FIG. 1 with another thread forming die head.

FIG. 4 is a schematic side view of another embodiment of a threading tool in accordance with the present subject matter.

FIG. 5 is a schematic side view of yet another embodiment of a threading tool in accordance with the present subject matter.

FIG. 6 is a schematic cross sectional view of an embodiment of a die head member used in the threading tools of the present subject matter.

FIG. 7 is a schematic cross sectional view of another embodiment of a die head member used in the threading tools of the present subject matter.

FIG. 8 is a schematic cross sectional view of another embodiment of a die head member used in the threading tools of the present subject matter.

FIG. 9 is a schematic cross sectional view of another embodiment of a die head member used in the threading tools of the present subject matter.

### DETAILED DESCRIPTION OF THE EMBODIMENTS

The present subject matter relates to handheld threading tools having provisions to apply force, and particularly axial force, to a workpiece or die head during a threading operation. In many embodiments, the tools also include liquid dispensing assemblies. Using the threading tool, a user can selectively dispense oil or other agents such as cutting agents and also apply an axial force to a thread forming die head by pushing the tool against the die head. The tools can be used such that oil or other agents are applied concurrently with the application of force to a die head, or vice versa. The tools can also be used such that oil or other agents are applied prior to and/or after application of force to a die head.

The provisions of the tool which contact the die head can have a variety of different shapes and configurations such as for example cone shaped, a “stepped” extended shape of concentric cylinders, a rounded arcuate face, and a “stepped” recess of concentric circular ledges in the form of a cover plate or other member that is positioned over the die head. These various provisions are referred to herein as die head members and are typically located along a front face or other region of the tool.

Generally, the tools of the present subject matter comprise a housing that typically includes a handle or gripping region. The tools also comprise a die head member affixed to or otherwise formed with the housing and adapted for contacting and transferring force to a die head. In many embodiments, the die head member is rotatable. The tools additionally comprise a spout or liquid transfer member. In certain embodiments, the spout extends from the housing. In other embodiments, the spout extends from the die head member. The spout defines a distal end through which liquid can flow and exit from the spout. In many embodiments, the tools additionally comprise a liquid dispensing assembly. Typically, such assembly includes a pump and a trigger or other actuator. Upon actuation of the trigger, the pump is operated to thereby displace liquid from a reservoir to the distal end of the spout. These and other aspects are as follows.

### Tools

### Tool Housings

The tools include a housing or enclosure which typically includes a handle or gripping region. The handle is sized and shaped to accommodate a user's hand or hands. The handle or gripping region may be textured or otherwise include friction promoting provisions to assist a user in securely holding or grasping the tool.

Generally, the housing and/or handle is formed from strong and durable materials typically used for industrial grade tools and particularly power tools. Nonlimiting examples of suitable materials may include various polymeric materials and metals and/or combinations of such.

### Die Head Members

As noted, the tools of the present subject matter include one or more die head members that are adapted to contact an end face of die head(s) typically used to form threads in tubular workpieces such as pipes. In many embodiments, the die head members are tailored, i.e., sized and shaped, to intimately contact an end face of one or more die heads.

The die head members are configured to contact and engage an end face of a thread forming die head. Nonlimiting examples of thread forming die heads include RIDGID Model Nos, 00-R, 12-R, and 11-R available from Ridge Tool Company. The present subject matter can be used in conjunction with nearly any type of thread forming or thread cutting die. The present subject matter also relates to thread freshening tools and thread cleaning operations. Typically, a thread forming die for forming external threads on a workpiece includes a housing or body having one or more thread cutting blades, tools, or chasers as known in the art. Nonlimiting examples of patents describing thread forming dies include U.S. Pat. Nos. 4,743,146; 2,014,312; and 2,054,745.

In many embodiments, the die head members are rotatable about their center axis. Thus, upon contacting a die head, if the die head undergoes rotation, the die head member can rotate with the die head. This is particularly advantageous if a user is applying axial force to the die head. However, it will be appreciated that the present subject matter includes embodiments in which the die head member is generally non-rotatable and thus is “fixed” or stationary with respect to the tool and/or its housing. For such versions of the tools, it may be desirable to include one or more low friction coatings on the die head member to reduce friction between the die head member and a rotating die head. Enabling rotation of the die head member relative to the tool and/or its housing is typically provided by use of one or more bearings or other assemblies as known in the art.

The die head members used in the tools of the present subject matter can exhibit a variety of different shapes and/or configurations depending upon the desired die head to which force is to be applied. For example, the die head members may be cone shaped and more particularly frustoconical, may utilize a stepped extended shape of concentric cylinders, may employ a rounded arcuate face and more particularly hemispherical, or may exhibit a stepped recess of concentric circular ledges. It will be appreciated that the present subject matter is not limited to any of these particular configurations.

Generally, the die head members are formed from durable and strong materials such as metals. However, the present subject matter includes the use of polymeric materials and/or composite materials.

In certain embodiments, the die head is oriented to be parallel or collinear with a longitudinal axis of the tool housing or handle. And, in other embodiments, the die head is oriented to be generally perpendicular to the longitudinal axis of the tool housing or handle. In certain embodiments, the die head member defines a centrally located liquid passageway. In other embodiments, the die head member is devoid or free of such passageways. The present subject matter includes a wide array of orientations of the die head member relative to the tool housing and/or handle.

The present subject matter also includes tools that can utilize one of a collection of differently sized, shaped, and/or configured die head members. Thus, in these embodiments a collection of interchangeable die head members can be used which enable a user to utilize a single tool and select a desired die head member from the collection for use with a specific die head.

### Spouts

The tools of the present subject matter include one or more spouts that transfer dispensed liquid to a location at or near a die head or region of thread formation. In certain embodiments, the spouts can extend generally from a center of the die head member. And, in other embodiments, the spouts can extend outward from the tool housing and spaced from the die head member. The present subject matter includes a wide array of orientations and positions for the spout relative to the tool and/or die head member.

The spout(s) are typically in the form of a fluid transfer component and include an interior flow line or path through which dispensed liquid flows. As noted, in many embodiments the spouts include a centrally located liquid passageway extending between opposite ends of the spout. The spouts can be rigid, or can be in the form of a flexible member.

### Liquid Dispensing Assemblies

The liquid dispensing assembly used in tools of the present subject matter typically include a pump and a trigger. The pump is in fluid communication with a liquid reservoir and upon actuation of the trigger, the pump displaces liquid from the reservoir and into and through the spout. In certain embodiments, one or more of the pump, trigger, and/or liquid reservoir are remote from the tool and thus not enclosed or disposed within the tool housing. For example, in one embodiment, the pump is remote from and not contained within the tool housing. In another embodiment, the liquid reservoir is remote from and not contained within the tool housing. For example, a remote liquid reservoir could be in the form of an “oiler bucket” as known in the art which is typically placed under a thread forming operation. In still another embodiment, both the pump and the liquid reservoir are remote from and not contained within the tool housing. In particular embodiments, all of the pump, trigger, and liquid reservoir are disposed within the tool housing. For example, it is contemplated that a liquid reservoir could be incorporated within the tool housing along with a pump that is manually operated or powered by an electric motor.

Generally, the trigger is sized and shaped to accommodate and receive a user's finger. In many embodiments, the trigger is supported on the tool housing and proximate the handle.

Details of pumps, triggers, liquid reservoirs, and associated components are known in the field of manual liquid dispensers and so are not repeated herein.

In many embodiments of the present subject matter, the liquid dispensing assembly is a manually operated assembly in which a user manually actuates a trigger or other member to displace liquid. However, the present subject matter includes powered liquid dispensing assemblies in which a motor is actuated which displaces liquid such as by operating a liquid pump. In such embodiments, an electrically powered motor can be used to drive a liquid pump. The motor can be powered by one or more batteries, which can for example be in the form of a removable and rechargeable battery pack. The battery pack could utilize one or more lithium ion battery cells for example.

### Methods

### Thread Forming Operations

A variety of techniques are known for forming helical screw threads on workpieces such as pipes or mechanical components. Subtractive methods involve thread cutting using taps or dies. Taps are typically used to form internal threads along the interior surface of an opening or blind hole. Dies are typically used to form external threads along outer surfaces of workpieces such as pipes or other cylindrical components. Single point tools are also known which can be used to form threads.

When forming threads and particularly in relatively hard materials and/or on workpieces such as pipes, large floor-standing threading machines are frequently used.

Threads can also be formed without using such large floor-standing machines. For example, handheld powered drives are known which can be used with one or more die heads to form threads on a pipe end. Manual ratchet drives are also known. Such handheld drives are used with thread forming die heads as previously described. A user aligns the die head with an end of a pipe or other workpiece and then rotates the die head about a center axis of the pipe using the drive. As noted, axial force is applied to the die head during or at least periodically during die head rotation. The rotating die head forms one or more threads in the pipe.

### Preferred Embodiment Methods

The present subject matter provides various methods related to thread forming operations. For example, the methods include a method for applying force to a die head during a threading operation and applying a liquid to the die head or region of interest. The liquid is typically oil, one or more lubricants, and/or one or more cutting agents as known in the art. Generally, such methods comprise providing a tool including a tool housing having a handle, a die head member affixed to the housing and adapted for contacting and transferring force to a die head, a spout defining a distal end through which liquid can flow and exit the spout, and a liquid dispensing assembly. The liquid dispensing assembly typically includes a pump and a trigger wherein actuation of the trigger operates the pump to displace liquid from a liquid reservoir to the distal end of the spout. However, it will be appreciated that a wide array of alternate versions of tools of the present subject matter could be used. The methods also comprise contacting the die head member of the tool with a die head and applying force thereto. And, the methods additionally comprise actuating the trigger of the liquid dispensing assembly of the tool to thereby operate the pump and displace liquid in the liquid reservoir to the distal end of the spout and dispense liquid from the tool to the die head or region of interest. In many applications, prior to displacing liquid, the die head member of the tool is not in contact with the die head. Instead, a user directs the distal end of the spout toward a location or region to receive the liquid upon trigger actuation.

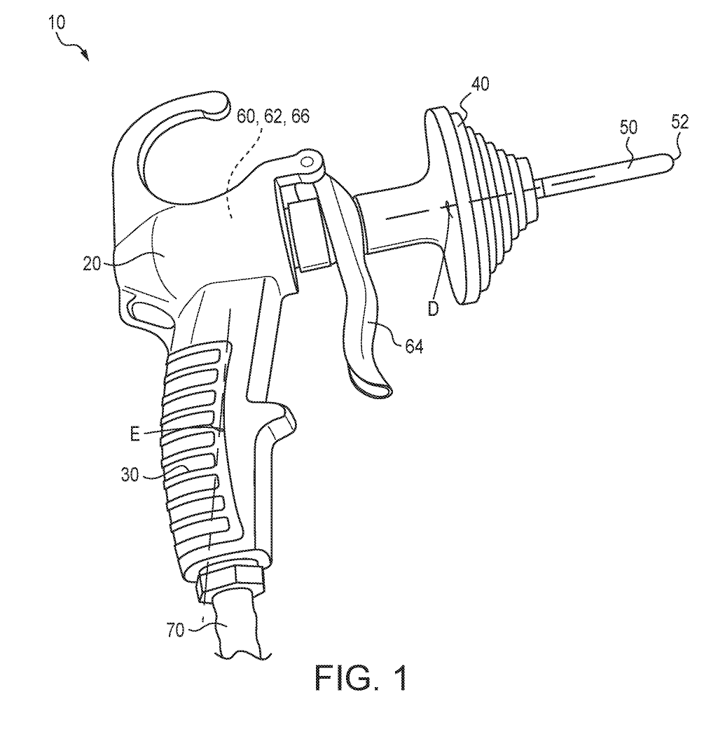

FIG. 1 illustrates an embodiment of a threading tool 10 in accordance with the present subject matter. The threading tool 10 comprises a tool housing 20 that includes a handle 30. The tool 10 also comprises a die head member 40 affixed or otherwise secured to the housing 20 and adapted for contacting and transferring force to a die head (not shown in FIG. 1). The die head member 40 exhibits a stepped configuration for contacting a die head. The tool 10 also comprises a spout 50 extending from the housing 20 and/or the die head member 40. The spout 50 defines a distal end 52 through which liquid can flow and exit the spout 50. The tool 10 also comprises a liquid dispensing assembly 60 typically at least partially enclosed and/or contained within the housing 20. The liquid dispensing assembly 60 includes a pump 62 and a trigger 64. Actuation of the trigger 64 operates the pump to displace liquid from a liquid reservoir 66 to the distal end 52 of the spout 50 to thereby dispense liquid from the tool 10. As described herein, in certain embodiments, the pump 62 and/or liquid reservoir 66 can be remote from and/or separate from the housing 20. In these versions of the tool, a liquid transfer conduit or hose 70 can be used to transfer the liquid from a remote reservoir to the tool 10 and spout 50.

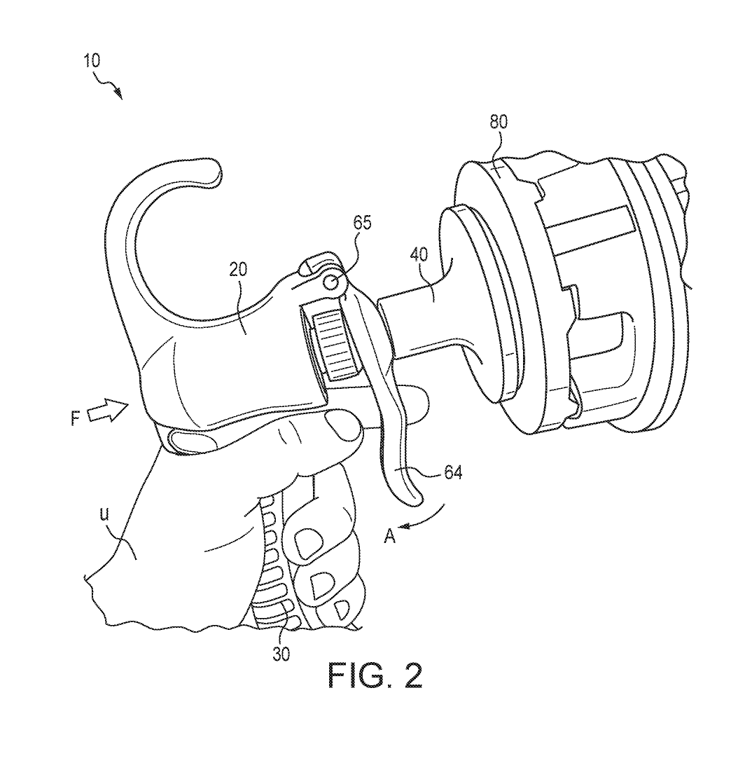

FIG. 2 illustrates use of the tool 10 to apply force, and particularly an axial force F, to a threading die head 80. A user U grasping the handle 30 applies force F to the die head 80 by contacting the die head member 40 against the die head 80 and pushing the member 40 against the die head 80. In many applications, the force F is aligned or at least substantially so, with a center axis of the die head 80. Liquid such as oil or cutting agent(s) is dispensed via the spout 50 by the user withdrawing the spout 50 (not shown) from the die head 80, directing the distal end 52 (not shown) of the spout toward a location or region to receive the liquid, and actuating the trigger 64 which in the representative embodiment shown, occurs by the user U pivoting the trigger about trigger hinge 65 in the direction of arrow A for example.

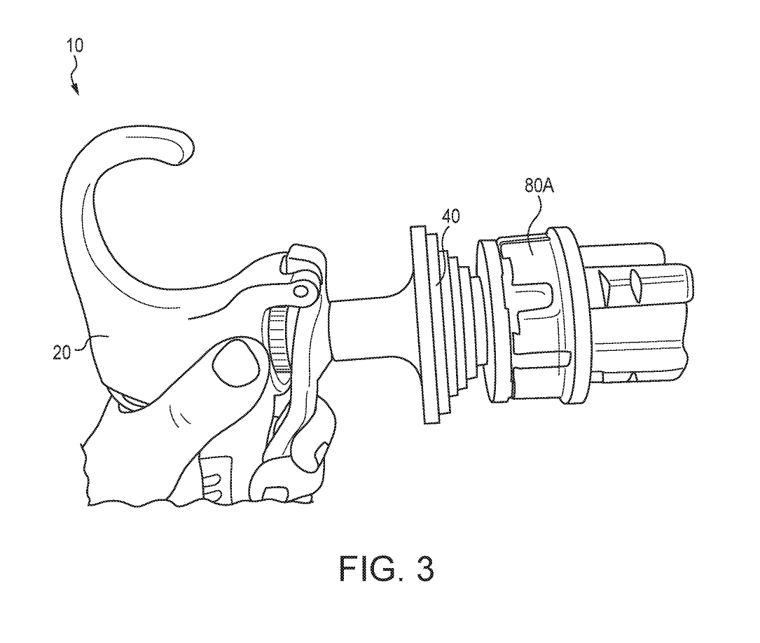

FIG. 3 illustrates the tool 10 being used with another die head 80A, different from the die head 80 shown in FIG. 2. In this representative embodiment, the stepped configuration of the die head member 40 enables engagement with a variety of different sizes of die heads such as 80 as shown in FIG. 2, and the relatively smaller diameter die head 80A as depicted in FIG. 3.

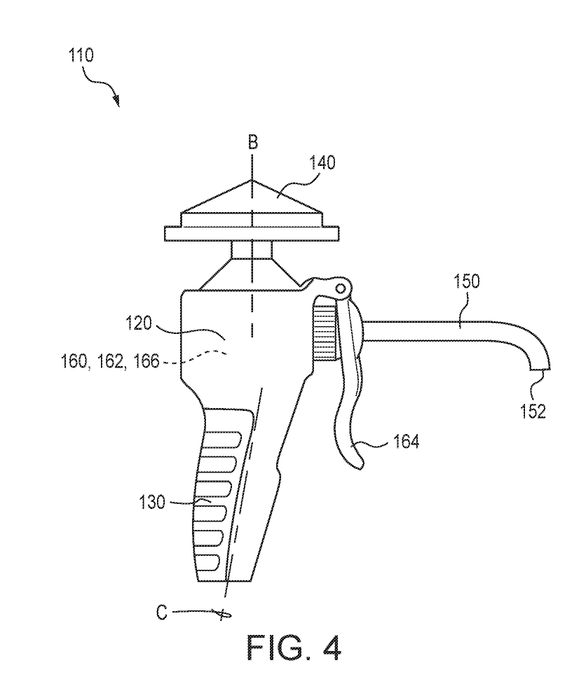

FIG. 4 illustrates another embodiment of a threading tool 110 in accordance with the present subject matter. The threading tool 110 comprises a tool housing 120 that includes a handle 130. The tool 110 also comprises a die head member 140 affixed to the housing 120 and adapted for contacting and transferring force to a die head. The die head member 140 includes a frustoconical shaped face for contacting a die head. The tool 110 also comprises a spout 150 extending from the housing 120 and/or the die head member 140. The spout 150 defines a distal end 152 through which liquid can flow and exit. The tool 110 also comprises a liquid dispensing assembly 160 that includes a pump 162 and a trigger 164. Actuation of the trigger 164 operates the pump 162 to displace liquid from a liquid reservoir 166 to the distal end 152 of the spout to thereby dispense liquid from the tool. In this embodiment, the pump 162 and the liquid reservoir 166 are both at least partially contained within and/or enclosed in the housing 120.

In the embodiment of tool 110, it will be appreciated that the die head member 140 is affixed directly to the housing 120, and that the spout 150 extends from the housing 120 in a direction different than that of the die head member 140. In addition, in this embodiment, the die head member 140 is oriented relative to the tool housing 120 such that a center axis B of the die head member 140 is parallel or collinear, or at least within about 20° of parallel, with a longitudinal axis C of the handle 130.

The present subject matter includes a variety of other configurations of die head member orientation and handle orientation. For example, as shown in FIG. 1, the die head member 40 is oriented relative to the tool housing 20 such that a center axis D of the die head member 40 is perpendicular or at least within about 20° of perpendicular, to a longitudinal axis E of the handle 30.

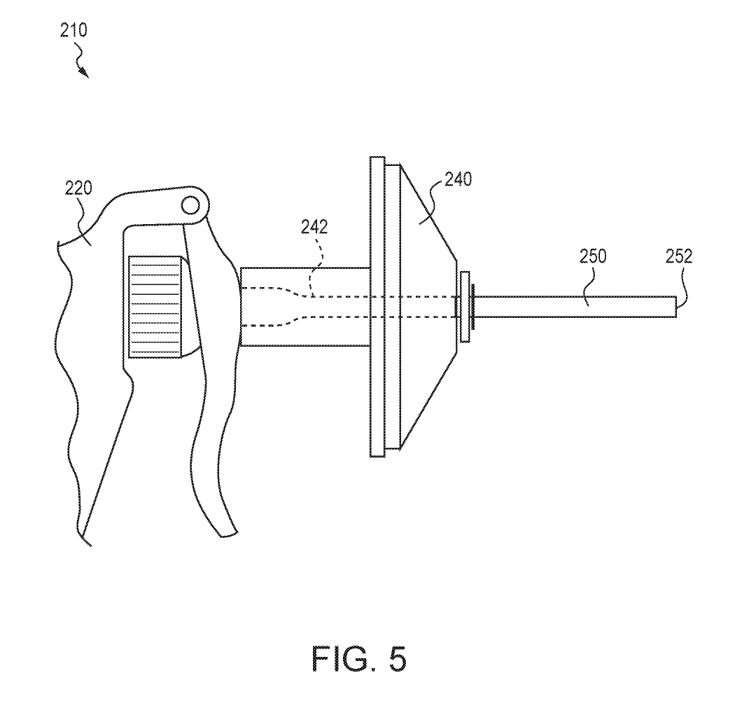

FIG. 5 schematically depicts another threading tool 210 in accordance with the present subject matter. In this embodiment, the tool 210 comprises a die head member 240 having a frustoconical shaped face for contacting and engaging a die head (not shown in FIG. 5). The tool 210 also comprises a tool housing 220 having a handle (not shown) and a liquid dispensing assembly (not shown) as previously described. The tool 210 also comprises a spout 250 defining a distal end 252. FIG. 5 schematically illustrates a liquid passageway 242 extending through the die head member 240. The passageway 242 provides flow communication between the liquid dispensing assembly and the spout 250. In many versions of the tools in which the spout extends directly from a die head member, the passageway 242 extends along a center axis of the die head member. In certain embodiments, the spout 250 extends through the passageway 242. In other embodiments, the spout 250 extends from a distal face or region of the die head member 240 and thus the passageway 242 directs liquid to the spout 250.

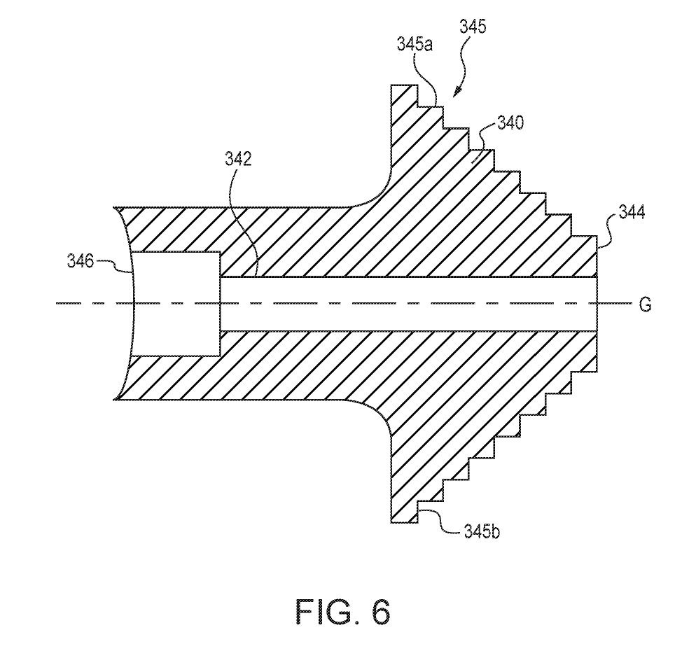

FIG. 6 is a schematic cross section of a die head member 340 having a stepped extended shape of concentric cylinders. The die head member 340 defines a fluid passageway 342 extending between a distal face 344 and an opposite proximal face 346. The passageway 342 extends along a center axis G. In many embodiments, a spout (not shown in FIG. 6) extends through the passageway 342. The stepped shape of the die head member 340 is characterized by a plurality of concentrically arranged steps 345, each resulting from a seat or first face 345a and a riser or second face 345b. Typically, the first and second faces are oriented at 90° to each other. However, the present subject matter includes a wide array of other step configurations. This shape or configuration for the die head enables the die head to engage a variety of different sized thread forming die heads. Typically, contact and engagement of the die head member occurs along an interior region or central aperture accessible along a circular end face of the die head. More specifically, in many embodiments, upon contact with a die head, the seat surface 345a serves to promote alignment with the die head and “pilots” on an interior face region of the die head; and the riser surface 345b “pushes” against the die head.

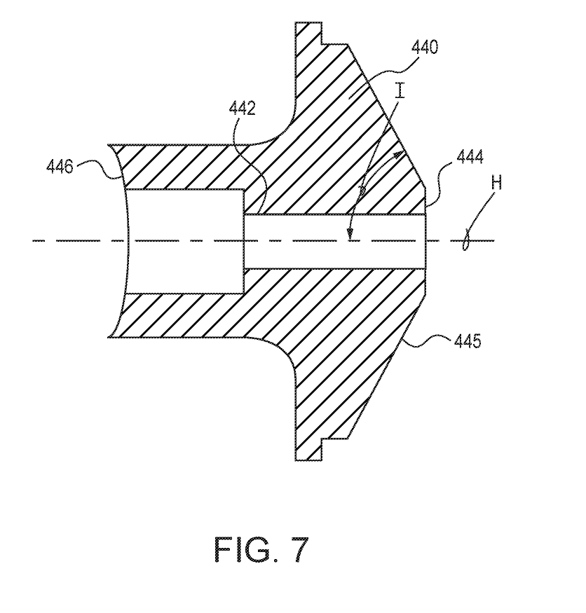

FIG. 7 is a schematic cross section of a die head member 440 having a frustoconical shape. The die head member 440 defines a fluid passageway 442 extending between a distal face 444 and an opposite proximal face 446. The passageway 442 extends along a center axis H. The die head member 440 also defines a tapered face 445 that results in the frustoconical shape. The frustoconical shape can exhibit a cross sectional angle I, taken from the center axis H, within a range of from about 10° to about 60° with 45° being typical for many applications. This shape or configuration for the die head enables the die head to engage a variety of different sized thread forming die heads. Typically, contact and engagement of the die head member occurs along an interior region or central aperture accessible along a circular end face of the die head. More specifically, in many embodiments, upon contact with a die head, the tapered face serves to promote alignment with the die head and also serves to transfer force, e.g., axial force, to the die head. The tapered face typically contacts an interior or inside circular edge of a die head.

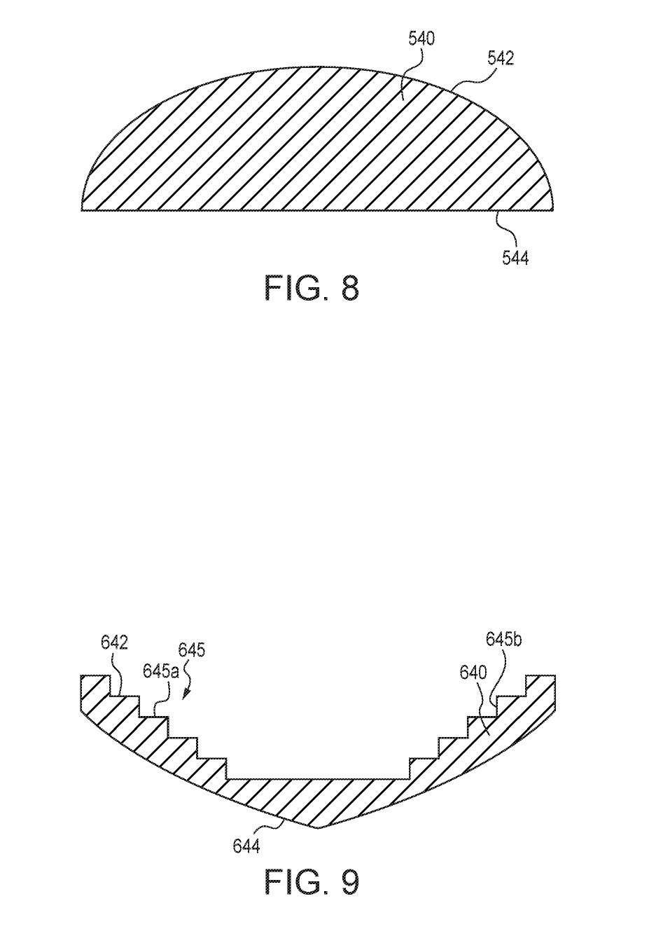

FIG. 8 is a schematic cross section of another die head member 540 having a rounded arcuate face. The die head member 540 defines a distal arcuate face 542 and an opposite proximal face 544. The die head member 540 may include a fluid passageway (not shown) extending between the faces 542 and 544. This shape or configuration for the die head enables the die head to engage a variety of different sized thread forming die heads. Typically, contact and engagement of the die head member occurs along an interior region or central aperture accessible along a circular end face of the die head. More specifically, in many embodiments, upon contact with a die head, the arcuate face 542 serves to promote alignment with the die head and also serves to transfer force, e.g., axial force, to the die head. The arcuate face typically contacts an interior or inside circular edge of a die head.

FIG. 9 is a schematic cross section of yet another die head member 640 having a stepped recess of concentric circular ledges 645. Each ledge 645 results from a seat or first face 645a and a riser or second face 645b. Typically, the faces 645a and 645b are oriented at 90° to each other, however, the present subject matter includes other arrangements. The die head 640 also defines a distal recessed face 642 and an opposite proximal face 644. The die head member 640 can include a liquid passageway (not shown) extending between the faces 642 and 644. This shape or configuration for the die head enables the die head to engage a variety of different sized thread forming die heads. Typically contact and engagement occurs between the recessed face of the die head member and an outer periphery of a circular end face of the die head. More specifically, in many embodiments, upon contact with a die head, the riser surface 645b serves to promote alignment with the die head and pilots on an exterior face region of the die head; and the seat surface 645a pushes against the die head.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A tool for applying force to a die head, the tool comprising:
a tool housing including a handle;
a die head member affixed to the housing and adapted for contacting and transferring force to a die head;
a spout extending from at least one of the tool housing and the die head member and defining a distal end through which liquid can flow and exit the spout.

2. The tool of claim 1 further comprising:
a liquid dispensing assembly including a pump and a trigger, wherein actuation of the trigger operates the pump to displace liquid from a liquid reservoir to the distal end of the spout to thereby dispense liquid from the tool.

3. The tool of claim 2 wherein the pump is disposed within the tool housing.

4. The tool of claim 2 wherein the pump is remote from the tool housing.

5. The tool of claim 2 wherein the trigger is supported on the tool housing and proximate the handle.

6. The tool of claim 1 wherein the die head member is oriented relative to the tool housing such that a center axis of the die head member is within 20° of perpendicular to a longitudinal axis of the handle.

7. The tool of claim 1 wherein the die head member is oriented relative to the tool housing such that a center axis of the die head member is parallel or collinear with a longitudinal axis of the handle.

8. The tool of claim 1 wherein the die head member defines a centrally located fluid passageway and the spout extends collinearly with an axis of the passageway.

9. The tool of claim 1 wherein the die head member is free of a fluid passageway.

10. The tool of claim 2 wherein the liquid dispensing assembly also includes the liquid reservoir, the liquid reservoir disposed within the tool housing.

11. The tool of claim 2 wherein the liquid dispensing assembly also includes the liquid reservoir, the liquid reservoir remote from the tool housing.

12. The tool of claim 1 wherein the die head member has a shape selected from the group consisting of a frustoconical shape, a stepped extended shape of concentric cylinders, a rounded arcuate face, and a stepped recess of concentric circular ledges.

13. The tool of claim 1 wherein the die head member is rotatable relative to the tool housing.

14. A tool for applying axial force to a die head, the tool comprising:
a tool housing including a handle;
a rotatable die head member engaged with the housing and adapted for contacting and transferring force to a die head.
a spout extending from one of the tool housing and the die head member, the spout defining a distal end through which liquid can flow and exit the spout;
a liquid dispensing assembly including a trigger.

15. The tool of claim 14 wherein the liquid dispensing assembly includes a pump that is remote from the tool housing.

16. The tool of claim 14 wherein the die head member is oriented relative to the tool housing such that a center axis of the die head member is within 20° of perpendicular to a longitudinal axis of the handle.

17. The tool of claim 14 wherein the die head member has a shape selected from the group consisting of a frustoconical shape, a stepped extended shape of concentric cylinders, a rounded arcuate face, and a stepped recess of concentric circular ledges.

18. A method for applying force to a die head during a threading operation and applying a liquid to the die head or region of interest, the method comprising:
providing a tool including a tool housing having a handle, a die head member affixed to the housing and adapted for contacting and transferring force to a die head, a spout defining a distal end through which liquid can flow and exit the spout, and a liquid dispensing assembly;
contacting the die head member of the tool with a die head and applying force thereto;
actuating the liquid dispensing assembly of the tool to thereby displace liquid to the distal end of the spout and dispense liquid from the tool to the die head or region of interest.

19. The method of claim 18 wherein the liquid is selected from the group consisting of oil, a cutting agent, and combinations thereof.

20. The method of claim 18 wherein applying force to the die head and actuating the liquid dispensing assembly occurs concurrently.
